(19) United States
(12) Patent Application Publication
(10) Pub. No.: US 2007/0195097 A1
(43) Pub. Date: Aug. 23, 2007

(54) Interactive Video

(75) Inventor: Michael Heesemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/596,597

(22) PCT Filed: Dec. 3, 2004
(86) PCT No.: PCT/IB04/52656

§ 371 Date: Jun. 19, 2006

(30) Foreign Application Priority Data
Dec. 19, 2003 (EP) 03104852.3

(51) Int. Cl. G06T 15/70

(52) U.S. Cl. 345/473

(57) ABSTRACT

Interactive video may involve user controlled characters. Additional interaction in broadcast interactive video may be provided by using video objects (3, 3′) and detecting any coincidence between a user controlled character (2) and the video objects. If coincidence is detected, an event may be triggered. Such an event may involve device control of the user controlled character

The present invention relates to interactive video. More in particular, the present invention relates to a device for and a method of providing interactive video.

Interactive video is well known, in particular computer games which produce video sequences locally and which allow some user interaction. However, also broadcast interactive video is enjoying an increasing interest. In several countries, television programs are now broadcast which allow the viewer a limited amount of interaction with remotely produced video sequences.

An example of an interactive broadcast video system is disclosed in United States Patent Application US 2003/0013526 where a central control establishes a virtual environment in which viewers participate with characters either controlled or designed by them. As a result, selected users are allowed to control characters that appear on a broadcast television show. However, there is no feedback from the video sequence and as a result there is no interaction between the controlled character and the remainder of the virtual environment shown in the video sequence.

U.S. Pat. No. 5,684,715 discloses an interactive video system which allows an operator to select an object moving in a video sequence. Upon selection, the flow of the interactive program may be altered or text messages may appear. To this end, video object information is used which is synchronized to objects in the video sequence. In this Prior Art video system, the user interaction is limited to flow changes and displayed messages, the user does not control the selected object.

It is an object of the present invention to overcome these and other problems of the Prior Art and to provide a device and a method for interactive video, in particular broadcast interactive video, which allow more user interaction.

Accordingly, the present invention provides a device for interactive video, the device comprising:
video reception means for receiving video image information,
character generator means for generating at least one user controllable character,
detection means for detecting any coincidence of a character and a video object associated with the received video image information, and
triggering means for triggering an event in response to any detected coincidence.

By using video image information and video object information associated with the video image information, it is possible to identify individual objects in the video information and determine their respective positions. Video objects, which are comprised in the video object information and define (dynamic or static) positions and/or contours of objects in the video image, are typically generated on the basis of the video image information and may be received with the video object information or be generated locally. By providing detection means for detecting a coincidence of a character and a video object, true interaction between a character and the video sequence becomes possible. The triggering means may trigger any suitable event, such as sounds, particular movements of the character and even the disappearance of the character. The event may therefore comprise a character control sequence.

The video information preferably is a substantially continuous broadcast video stream which preferably comprises both the video image information and the associated video object information. However, the present invention may also be applied to video image information (and any associated video object information) originating from a data carrier, such as a DVD. The video objects may be defined in accordance with International Standard MPEG-4 as this standard already allows for accommodating video objects in different video layers. Other standards, in particular interactive television standards may also be used, for example MHP (“Multimedia Home Platform”, part of the standard for Digital Video Broadcast DVB, as explained in more detail at http://www.mhp.or ) and OpenTV. These standards typically add an interactive layer to the video stream, said layer containing video object information such as the location and size of various objects in the video stream. In accordance with the present invention, this interactive layer may be dynamically linked with the video stream.

Advantageously, the device according to the present invention may further comprise control input means for receiving character control signals produced in response to user input. This allows a user to control a video character. As a result, the “behavior” of the character is determined both by the user and by the video objects of the video stream. The present invention, therefore, allows interaction between a character and a user (“player”) and between a character and its “environment”, that is, the video objects surrounding the character.

In an advantageous embodiment the character generator means, the detection means and/or the triggering means are constituted by a microprocessor. This allows the said means to be constituted by substantially a single component.

The device of the present invention is advantageously constituted by a set-top box and/or by a game console.

The present invention further provides a system for interactive video, the system comprising:
a video source for providing video image information and any associated video object information,
transmission means for transmitting the video image information and any associated video object information,
reception means for receiving the transmitted video image information and any associated video object information,
a display screen for displaying the received video image information, and
a device as defined above.

Such a system allows truly interactive broadcast video. The video source may comprise a remote station or a local video storage unit. The video source may produce video object information if such information is available. The transmission means may comprise known digital television transmission systems but may, in the case of a local video storage unit, comprise a local network or a cable. The reception means and the display screen may together be constituted by a television set, preferably a digital television set. The device of the present invention may be constituted by a set-top box or a game console, or may be integrated in the television set.

The system of the present invention advantageously further comprises a video object information generator for generating video object information on the basis of the received video image information. The video object generator may operate in accordance with a known Standard, such as MPEG-4 or OpenTV and may produce video object descriptors as defined in said Standards.

The present invention also provides a method of providing interactive video, the method comprising the steps of:
receiving video image information,
generating at least one user controllable character,
detecting any coincidence of a character and a video object associated with the received video image information, and
triggering an event in response to any detected coincidence.

When both the video information containing the video objects and the user controllable character(s) are displayed on a suitable display screen, for example a television screen, a user controlled character can truly interact with the video image.

The present invention additionally provides a computer program product for carrying out the method as defined above. A ‘computer program’ is to be understood to mean any software product stored on a computer-readable medium, such as a floppy-disk, downloadable via a network, such as the Internet, or marketable in any other manner.

The present invention will further be explained below with reference to exemplary embodiments illustrated in the accompanying drawings, in which:

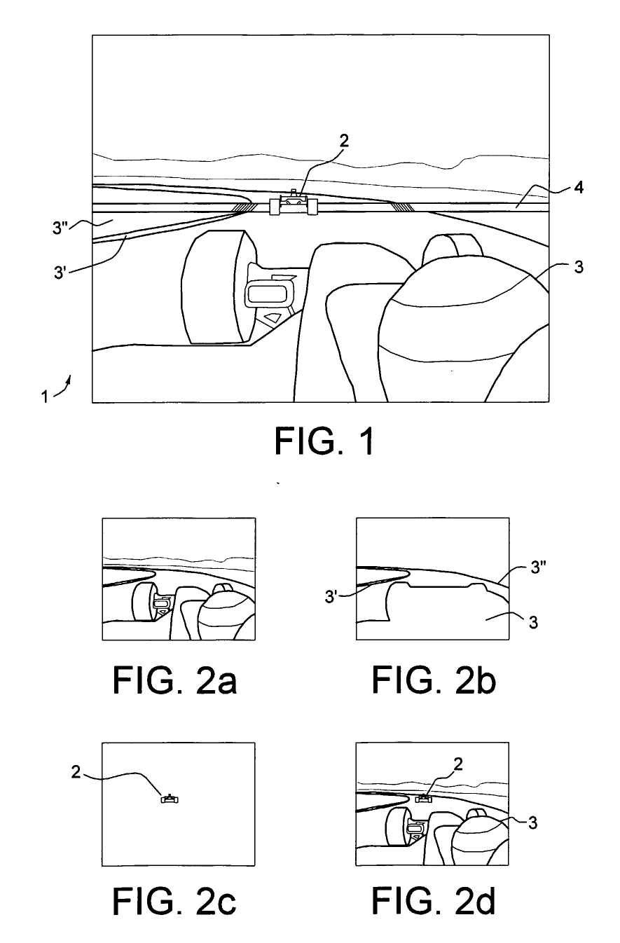

FIG. 1 schematically shows an interactive video image according to the present invention.

FIGS. 2a-d schematically show the constituent parts of the interactive video image of FIG. 1.

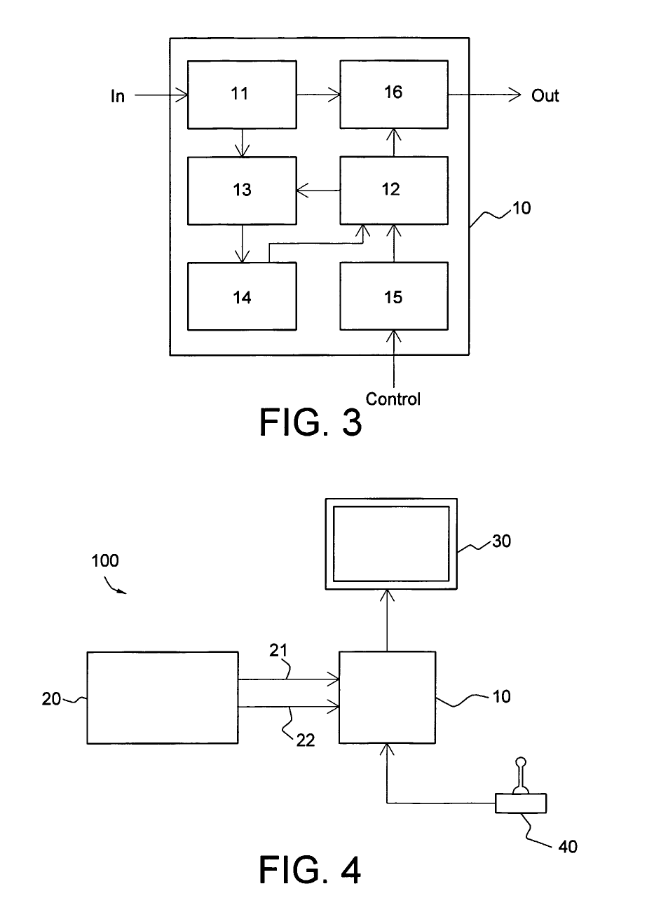

FIG. 3 schematically shows a device for providing interactive video according to the present invention.

FIG. 4 schematically shows a system for providing interactive video according to the present invention.

The interactive video image 1 shown merely by way of non-limiting example in FIG. 1 comprises a user controlled character 2, video objects 3, 3′ and 3″ and a game bar 4. The constituent parts of the image 1 are shown in FIGS. 2a-d. The original video image of FIG. 2a is, in the embodiment shown, a television image and is part of a substantially continuous video stream. The original video image of FIG. 2a may be watched as such, but viewers having the appropriate equipment may enjoy a video stream which is enhanced with interactive characters.

To this end, a set of video objects as shown in FIG. 2b is associated with the image. The racing car shown constitutes video object 3, the border of the race track is video object 3′ while the grass at the other side of the border constitutes video object 3″. The video objects may be relatively static, or (very) dynamic, in dependence on the content of the video stream.

Typically, the video objects are transmitted with the video stream, and are generated at the transmission end, that is, remotely. It is, however, also possible to generate video objects locally at the receiving end, in a device at the user's premises.

A user controllable character is shown in FIG. 2c. In the example shown, the character is a racing car. This character is generated by a user device, that is, locally and is added to the video image of FIG. 2a to form the composite video image of FIG. 1. It is noted that in FIG. 1 an optional game bar 4 is added, this game bar assists in tracking the user controlled character but is not essential.

Although not visible in the image 1, the video objects 3, 3′, 3″ are available and are used to provide interaction between the user controlled character and the image. To this end, the present invention provides detection of any coincidence of a character and a video object. In the example shown, this would for example involve the detection of any coincidence of the character 2 and the track border video object 3′. If the character 2 and the track border 3′ coincide, an event could be triggered. This event could involve the loss of points or a control sequence, such as a sudden movement or even the destruction of the character (crash). It is noted that this event control sequence overrides any user control.

The coincidence of a character and a video object can be detected on the basis of overlap. In a digital image, it can be easily detected that a character and a video object involve the same pixels (picture elements). Instead of simple overlap, more sophisticated coincidence detection procedures can be used which take the viewing angle into account. In the image of FIG. 1, for instance, the actual racing car (video object 3) and the virtual racing car (character 2) could collide. In a top view, this would be detected by any overlap of the cars as shown in the image. In the view of FIG. 1, however, having an acute viewing angle, simple overlap will result in an early detection and a more realistic collision detection would require an adjustment for the particular viewing angle. Such an adjustment could be carried out, for example, by associating an auxiliary video object with the video object 3, the dimensions of the auxiliary video object varying with the viewing angle. To this end, it would be advantageous to add (an estimate of) the viewing angle to the video stream.

Instead of, or in addition to the detection of any overlap, the “coincidence” of a character and a video object can also be detected on the basis of proximity. That is, the behavior of a video character may depend on the proximity of a video character, even in the absence of any overlap. A suitable proximity measure may be defined, which measure may depend on the relative sizes of the video character and the video object, the particular video stream, and other factors. Any proximity may be measures in pixels or any other suitable units, such as percentages of the screen size.

The device 10 according to the present invention shown schematically in FIG. 3 comprises a video reception unit 11 for receiving an input video signal comprising video information containing video objects 3, a character generator unit 12 for generating at least one user controllable character 2, a detection unit 13 for detecting any coincidence of a character 2 and a video object 3, a triggering unit 14 for triggering an event in response to any detected coincidence, and a control input unit 15 for receiving character control signals. In the embodiment shown, the device 10 further comprises a video combination unit 16 for combining video information from the video reception unit 11 and the character generator unit 12 so as to produce an output video signal.

The video reception unit 11 receives a video signal containing both video image information and video object information. The video image information is fed to the combination unit 16 while the video object information is passed to the detection unit 13. The control input unit 15 receives user control signals from a user device such as a joy stick, a mouse, or a remote control unit. Suitable control signals are passed from the control input unit 15 to the character generator unit 12 to control user controlled characters. The character generator unit 12 outputs character information to both the combination unit 16 and the detection unit 13. As the detection unit 13 receives both video object information and character information it is capable of detecting any coincidence of the character and the video objects. If such coincidence is detected, the detection unit 13 produces a detection signal which is passed to the triggering unit 14 which in turn may trigger suitable events. The particular type of event may depend on the character and video object(s) involved and may include the production of a visual and/or aural message, carrying out a control sequence involving the character concerned, or any other event. If a control sequence is activated, the triggering unit 14 passes suitable signals to the character generator 12 to control the character. It is noted that in the case of a control sequence initiated by the triggering means 14, this control sequence typically overrides any user control signals. The combination unit 16 outputs the combined video signals of the video reception unit 1 and the character generator unit 12.

Although the various units of the device 10 are shown as distinct units for the sake of clarity of the illustration, embodiments can be envisaged in which two or more units are combined into a single unit. Such a single unit can be constituted by a suitable microprocessor and associated memory, and/or by an application specific integrated circuit (ASIC).

The system 100 shown merely by way of non-limiting example in FIG. 4 comprises an interactive video device 10 as described above, a video source 20, a display screen 30 and a user control device 40. The video source 20 preferably comprises a transmission channel, such as a cable network, for transmitting remotely produced video information in real time. However, the video source 20 may also comprise a device for reproducing stored video information, such as a DVD player.

The video information originating from video source 20 and input into the interactive video device 10 preferably comprises both video image information and video object information. This is schematically indicated in FIG. 4 by the arrows 21 and 22 respectively. It will be understood that in actual embodiments both types of video information may be conveyed using a single cable, although separate cables may be used.

The interactive video device 10 received control signals from the user control device 40 which may be a joy stick, a mouse or any other suitable device for producing user control signals. The output signal of device 10 (see also FIG. 3) is fed to the display device 30 which may be a television set, a computer, a separate display screen or any other device capable of rendering the combined video information output by the device 10.

It is noted that in the example of FIG. 4 it is assumed that the video object information is produced remotely and that the device 10 receives this information (arrow 22), together with the video image information. However, it is also possible for the device 10 to produce the video object information locally. To this end, the device 10 would require a video object generator for generating video objects on the basis of video image information.

The present invention is based upon the insight that it is possible to add interaction between characters and a video stream by detecting any coincidence between the characters and video objects associated with the video stream. In this way, characters may be controlled both by a user and by the video stream.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (10) for interactive video, the device comprising:
video reception means (11) for receiving video image information,
character generator means (12) for generating at least one user controllable character (2),
detection means (13) for detecting any coincidence of a character (2) and a video object (3) associated with the received video image information, and
triggering means (14) for triggering an event in response to any detected coincidence.

2. The device according to claim 1, further comprising control input means (15) for receiving character control signals.

3. The device according to claim 1, wherein an event involves device control of the user controllable character.

4. The device according to claim 1, wherein the video reception means (11) are arranged for additionally receiving video object information associated with the received video image information.

5. The device according to claim 1, further comprising video object information generator means for generating video object information associated with the received video image information.

6. The device according to claim 1, constituted by a set-top box or a game console.

7. The device according to claim 1, wherein the character generator means (12), the detection means (13) and/or the triggering means (14) are constituted by a microprocessor.

8. The device according to claim 1, wherein the user controllable character is a car, preferably a racing car.

9. A system (100) for interactive video, the system comprising:
a video source (20) for providing video image information and any associated video object information,
transmission means for transmitting the video image information and any associated video object information,
reception means for receiving the transmitted video information and any associated video object information,
a display screen (30) for displaying the received video information and any associated video object information, and
a device (10) according to claim 1.

10. The system according to claim 9, further comprising a video object information generator for generating video object information on the basis of video information.

11. The system according to claim 9, further comprising a control device (40) arranged for producing character control signals in response to input from a user.

12. A method of providing interactive video, the method comprising the steps of:
receiving video image information,
generating at least one user controllable character (2),
detecting any coincidence of a character (2) and a video object (3) associated with the video image information, and
triggering an event in response to any detected coincidence.

13. The method according to claim 12, comprising the additional step of:
receiving video object information associated with the received video image information.

14. (canceled)
